(19) United States
(12) Patent Application Publication
(10) Pub. No.: US 2026/0295608 A1
(43) Pub. Date: Oct. 1, 2026

(54) POSITION ADJUSTABLE FLOW CONTROL DEVICE

(71) Applicant: AS America, Inc., Piscataway, NJ (US)

(72) Inventors: David Espirito Santo, Colonia, NJ (US); Xiaojing Ye, Edison, NJ (US)

(73) Assignee: AS America, Inc., Piscataway, NJ (US)

(21) Appl. No.: 19/633,592

(22) Filed: Mar. 30, 2026

Related U.S. Application Data
(60) Provisional application No. 63/781,021, filed on Mar. 31, 2025.

(51) Int. Cl. B05B 1/30; B05B 1/18

(52) U.S. Cl. CPC B05B 1/3006; B05B 1/189; B05B 1/3013

(57) ABSTRACT

A fluid control device for controlling fluid flow are provided herein. The device includes a first element with a plurality of openings and a second element with pins aligned with the openings. The elements are positioned adjacent to each other, with one element movable relative to the other. As the elements move relative to each other, the pins extend into or retract from the openings, controlling fluid flow characteristics. An actuator controls this movement, enabling either manual adjustment via a rotary lever for user-selected spray patterns or automatic adjustment via a spring-loaded assembly responding to fluid pressure. When the pins fully extend into the openings, they create a seal that prevents dripping when water is turned off. When partially extended, they create various spray patterns from gentle to powerful.

### CROSS-REFERENCE TO RELATED APPLICATIONS

The application is related to and claims priority benefit of U.S Provisional Application No. 63/781,021, entitled “POSITION ADJUSTABLE FLOW CONTROL DEVICE” filed Mar. 31, 2025, the contents of which are hereby incorporated by reference in their entirety into the present disclosure.

### FIELD OF THE DISCLOSURE

Embodiments of the present disclosure relate generally to fluid delivery devices and, more particularly, to fluid control devices and methods for modifying fluid flow through adjustable nozzle assemblies within showerheads, hand showers, faucet spray heads, and similar fluid delivery fixtures.

### BACKGROUND OF THE DISCLOSURE

In fluid delivery fixtures, particularly in plumbing applications, controlling and modifying fluid flow is necessary for both functionality and user experience. Traditional fixtures like showerheads and faucet spray heads often employ multiple sets of fixed nozzles to provide different spray patterns or flow characteristics. These designs typically require complex internal mechanisms to divert water between different nozzle sets to achieve varying spray patterns.

One challenge in managing fluid flow through such fixtures is providing effective control over spray patterns while maintaining simplicity in design. Conventional approaches often require numerous components and complicated assemblies to achieve multiple spray patterns, making manufacturing more complex and potentially increasing points of failure. Additionally, these traditional designs may not effectively prevent post-use dripping, which can waste water and create unwanted water marks on fixtures.

Further challenges arise in maintaining consistent spray performance across varying water pressures. Many existing systems provide either excessive flow at high pressures or insufficient flow at low pressures, leading to inconsistent user experiences. Some fixtures attempt to address this through pressure-regulating components, but these often add complexity and cost to the system.

Moreover, current designs frequently require different mechanisms for controlling spray patterns versus managing drip prevention. This separation of functions results in additional components and increased manufacturing complexity. Some systems may employ separate gaskets or seals for preventing drips, while others require different mechanical assemblies for spray pattern control, leading to more complicated and potentially less reliable products.

Consequently, there is a need for an improved fluid control device that can effectively manage both spray patterns and drip prevention while maintaining design simplicity. Additionally, there is a need for systems that can better handle varying water pressures while providing consistent performance. Accordingly, various embodiments detailed herein provide improved devices and methods for controlling fluid flow through delivery fixtures.

### BRIEF SUMMARY OF THE DISCLOSURE

Embodiments of the present disclosure provide various devices and methods that address many of the above noted difficulties and challenges associated with controlling fluid flow in delivery fixtures. In this regard, various embodiments of the present disclosure provide systems for controlling fluid flow through adjustable nozzle assemblies in a way that enables both manual adjustment of spray patterns and automatic response to water pressure, while also providing effective drip prevention when water flow is stopped.

The devices and methods disclosed herein improve upon traditional designs by implementing a dual-element control system that can modify fluid flow through relative movement between two elements containing aligned openings. This approach enables a single mechanism to serve multiple functions - from providing variable spray patterns to preventing post-use dripping. The system can be implemented in various fixtures including showerheads, hand showers, and faucet spray heads, offering improved functionality while potentially reducing manufacturing complexity compared to conventional designs.

Traditional fluid delivery fixtures typically require multiple sets of nozzles and complex internal mechanisms to achieve different spray patterns. They often lack effective drip prevention and may not respond well to pressure variations. In contrast, the present disclosure describes devices that can achieve multiple functions through a single, elegant mechanism. By utilizing relative movement between two elements with aligned openings, the system can provide variable spray patterns, pressure response, and drip prevention without requiring separate mechanisms for each function.

The devices and methods disclosed herein offer advantages over conventional approaches. The system's ability to combine multiple functions in a single mechanism can reduce manufacturing complexity while improving reliability. This enables for both manual adjustment for user-selected spray patterns and automatic response to water pressure changes, providing enhanced user experience and better performance across varying conditions.

In an example embodiment, a fluid device is provided. The fluid device comprises a first element comprising a plurality of openings; a second element positioned adjacent to the first element, the second element comprising a plurality of pins, wherein the plurality of pins are aligned with the plurality of openings of the first element. One of the first element or the second element is movable relative to the other element between a first position and a second position, the first position allowing fluid flow through the plurality of openings and the second position modifying the fluid flow through the plurality of openings. The fluid device further comprises an actuator configured to move one of the first element or second element relative to the other element.

In some embodiments, the first element comprises a top surface and a bottom surface, and wherein the plurality of openings extend from the top surface to the bottom surface.

In some embodiments, the second element comprises a top surface and a bottom surface, and wherein the plurality of pins extend from the bottom surface of the second element toward the first element.

In some embodiments, the bottom surface of the second element is positioned above the top surface of the first element.

In some embodiments, each of the plurality of openings of the first element comprises a shape configured to receive a corresponding pin of the plurality of pins.

In some embodiments, the actuator comprises a pressure-responsive mechanism configured to automatically adjust the position of one of the first or second element relative to the other element based on fluid pressure.

In some embodiments, the pressure-responsive mechanism comprises a spring-loaded assembly configured to: push the plurality of pins into the plurality of openings when fluid pressure is below a threshold; and enable the plurality of pins to retract from the plurality of openings when fluid pressure exceeds the threshold.

In some embodiments, the actuator comprises a manual control mechanism configured to enable user adjustment of the position of one the first or second element relative to the other element

In some embodiments, the manual control mechanism comprises a rotary lever connected to a spindle, wherein the spindle is configured to convert rotational movement into linear movement of one the first or second element relative to the other element.

In some embodiments, the second position, the plurality of pins extend into the plurality of openings to create a reduced cross-sectional area for fluid flow.

In some embodiments, the reduced cross-sectional area configured to create a higher velocity fluid spray.

In some embodiments, the first position, the plurality of pins are retracted from the plurality of openings to create a maximum cross-sectional area for fluid flow.

In some embodiments, when the plurality of pins fully extend into the plurality of openings, fluid flow is completely stopped.

In some embodiments, the first position and second position define a range of intermediate positions therebetween, wherein each intermediate position is configured to create a different water flow rate based on the degree to which the plurality of pins extend into the plurality of openings.

In some embodiments, the relative movement between the first element and the second element is in a longitudinal direction.

In some embodiments, the spring-loaded assembly is configured to seal the plurality of openings when water pressure is absent.

In some embodiments, the plurality of pins and the plurality of openings are configured to create larger flow gaps when fluid pressure increases and smaller flow gaps when fluid pressure decreases.

In some embodiments, the plurality of openings are arranged in at least one row.

In some embodiments, the plurality of pins have a tapered shape configured to create a seal when fully inserted into the plurality of openings.

In some embodiments, the fluid device further comprising a sealing member between the first element and the second element.

In some embodiments, the manual control mechanism is accessible from an exterior of the fluid control device.

In some embodiments, movement of the plurality of pins into and out of the plurality of openings during operation provides a self-cleaning function.

In some embodiments, the fluid control device is incorporated into a shower head.

In some embodiments, the fluid control device is incorporated into a hand shower.

In some embodiments, the fluid control device is incorporated into a faucet spray head.

In some embodiments, the fluid control device produces multiple spray patterns.

In some embodiments, the rotary lever is movable through an angle of movement between 0 and 360 degrees, and wherein each incremental movement is configured to change a spray pattern produced by the fluid control device.

In some embodiments, the first element and the second element are configured to accommodate a range of fluid pressures while maintaining a consistent spray pattern.

In some embodiments, the first element and the second element form a chamber configured to receive fluid, and wherein the fluid in the chamber causes fluid pressure that contributes to the movement between the first position and the second position.

In some embodiments, the fluid control device is configured to convert between spray patterns without redirecting fluid flow through separate fluid pathways.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1A illustrates an example shower enclosure with a drip-stop nozzle installed, in accordance with some embodiments disclosed herein;

FIG. 1B illustrates an exploded view of the drip-stop nozzle of FIG. 1A, showing the component parts, in accordance with some embodiments discussed herein;

FIG. 1C illustrates a cross-sectional view of the drip-stop nozzle of FIG. 1A in a closed position, showing the relationship between the pins and nozzle openings when water pressure is absent, in accordance with some embodiments discussed herein.

FIG. 1D illustrates a cross-sectional view of the drip-stop nozzle in an open position, showing the position of the pins relative to the nozzle openings when water pressure is applied, in accordance with some embodiments discussed herein;

FIG. 2A illustrates an example shower enclosure with a manually nozzle installed, in accordance with some embodiments disclosed herein;

FIG. 2B illustrates a top view of the manually adjustable nozzle of FIG. 2A, showing the rotary lever and the arrangement of conical nozzle openings, in accordance with some embodiments discussed herein;

FIG. 2C illustrates an exploded view of the manually adjustable nozzle, showing the component parts, in accordance with some embodiments discussed herein;

FIG. 2D illustrates a cross-sectional view of the manually adjustable section nozzle in a closed position, showing the relationship between the pins and nozzle openings when the rotary lever is in a first position, in accordance with some embodiments discussed herein;

FIG. 2E illustrates a cross-sectional view of the manually adjustable nozzle in an open position, showing the position of the pins relative to the nozzle openings when the rotary lever is in a second position, in accordance with some embodiments discussed herein; and

FIG. 2F illustrates a front view of a hand shower variation of the manually adjustable nozzle system, in accordance with some embodiments discussed herein.

### DETAILED DESCRIPTION

Exemplary embodiments of the present disclosure will be described more fully hereinafter with reference to the accompanying drawings, in which some, but not all embodiments of the present disclosure are shown. Indeed, the present disclosure may be embodied in many different forms and should not be construed as limited to the exemplary embodiments set forth herein; rather, these embodiments are provided so that this disclosure will satisfy applicable legal requirements. Like reference numerals refer to like elements throughout.

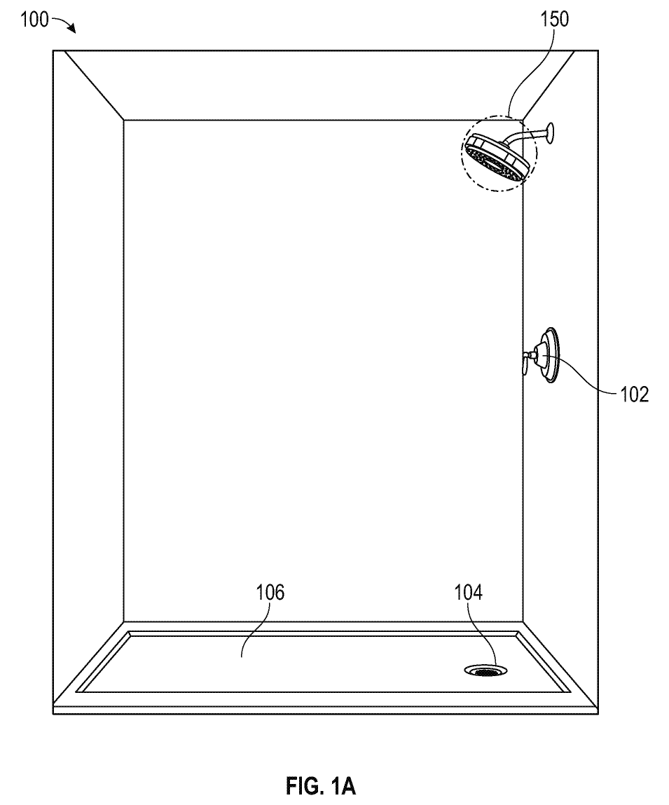

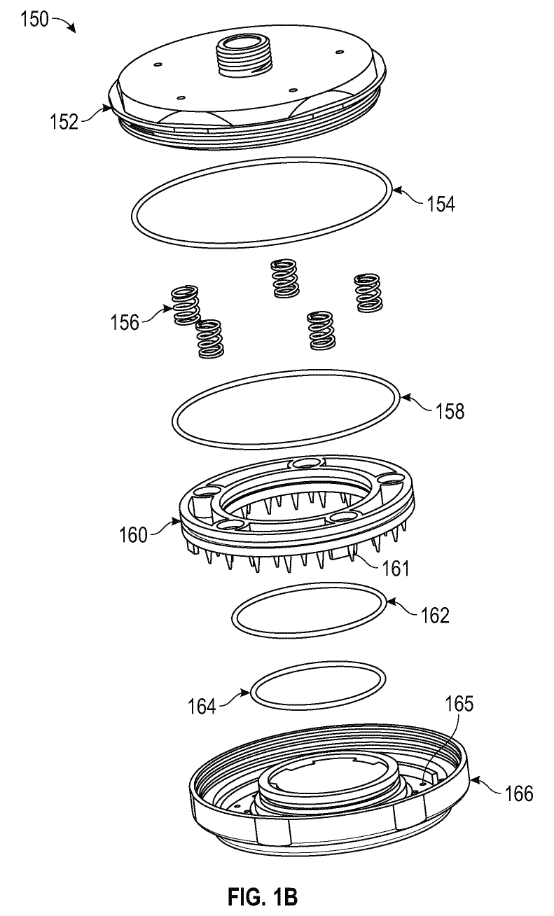

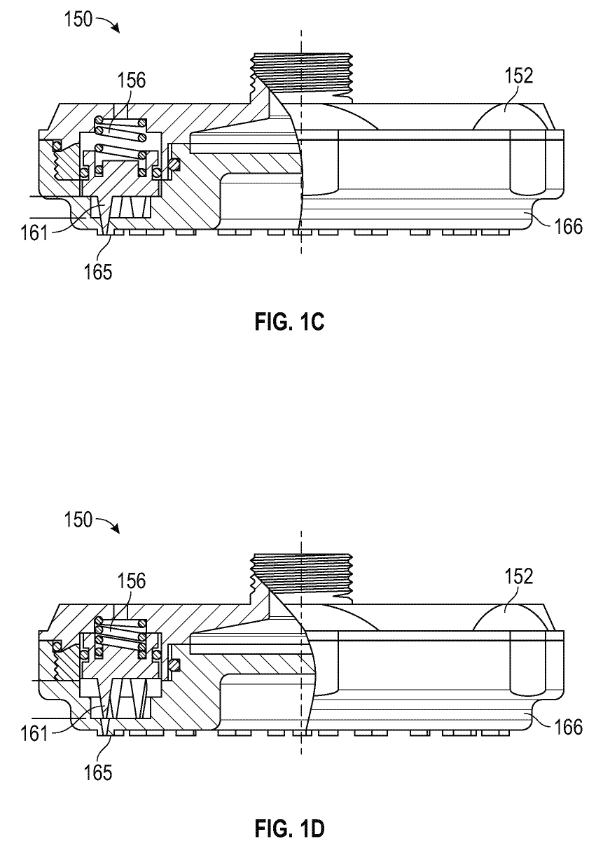

FIG. 1A illustrates a shower enclosure 100, serving an example environment for implementing a fluid control device in the form of a shower head 150 with drip-stop nozzles. The shower enclosure 100 includes the shower head 150, a shower handle 102, a drain 104, and a floor 106.

Shower head 150 is a fluid delivery fixture that incorporates a fluid control mechanism as described in the present disclosure. Shower head 150 is connected to a water supply system that typically provides both hot and cold water through plumbing connected to shower handle 102. Shower handle 102 is a user interface device that enables the user to control the flow and temperature of the water delivered by the shower head 150. The shower handle 102 may be connected to a mixing valve that combines hot and cold water to achieve the desired temperature. When the user turns the shower handle 102 to the off position, the water pressure to the shower head 150 is reduced, activating the drip-stop functionality.

Drain 104 is a plumbing fixture located on floor 106 of shower enclosure 100. Drain 104 collects and removes water that flows from the shower head 150. The floor 106 of the shower enclosure 100 is typically sloped toward drain 104 to facilitate the flow of water away from the standing area.

Shower head 150 may be mounted on a wall of the shower enclosure 100, as shown in FIG. 1A. The mounting may include standard plumbing connections that enable for easy installation in new construction or as a replacement for existing shower fixtures. The external appearance of shower head 150 may be similar to conventional showerheads, with the fluid control mechanism contained within its housing.

Shower head 150 includes an internal mechanism that operates through relative movement between two elements, each containing a plurality of openings. Within shower head 150, a needle plate with conical pins is configured to move relative to a faceplate with matching conical openings. When water pressure is applied, the pins retract from the openings, enabling water to flow. When water pressure drops, the pins extend into the openings, effectively sealing them to prevent dripping. This pressure-responsive mechanism in shower head 150 uses compression springs that apply force to the needle plate, pushing the conical pins toward the conical openings. When water pressure is present and exceeds the spring force, the needle plate moves against the spring force, retracting the pins from the openings. When water pressure decreases below the spring force threshold, the springs push the needle plate back, extending the pins into the openings and creating a seal. In some embodiments, the conical openings are a plurality of holes, or circular openings. In some embodiments, the circular openings may be of different shapes.

The drip-stop functionality of shower head 150 helps prevent unnecessary water waste and reduces the formation of mineral deposits that might otherwise occur from continuous dripping onto the floor 106 or into drain 104 after the shower is turned off. This helps maintain the cleanliness of floor 106 by preventing water spotting and mineral buildup that can occur from continuous dripping after use.

Shower head 150 can also respond to varying water pressures during normal operation, providing more consistent water flow regardless of the supply pressure. As water pressure increases, the pins retract further from the openings, creating larger flow paths. As water pressure decreases, the pins extend closer to the openings, creating smaller flow paths. This automatic adjustment helps maintain consistent water velocity across different pressure conditions.

The movement of pins within the shower head 150 as they retract and extend during normal operation provides an additional benefit of self-cleaning the openings. This movement can dislodge accumulated minerals or debris that might otherwise restrict water flow through the openings over time, potentially extending the operational life of the fixture.

The fluid control device incorporated in the shower head 150 achieves these benefits through a relatively simple configuration that does not require electronic components or external power sources, making it reliable and cost-effective. The same fluid control technology can be adapted to various other fluid delivery fixtures, including but not limited to hand showers, faucet spray heads, and other plumbing fixtures where controlled fluid delivery and drip prevention are desirable.

FIG. 1B illustrates an exploded view of shower head 150 showing the individual components and their arrangement within the assembly. Shower head 150 comprises multiple components configured to work together to provide both water delivery and automatic water drip prevention functionality.

Top cover 152 forms the upper housing portion of shower head 150 and includes an inlet for connecting to the water supply. Top cover 152 has a generally circular shape with threaded connections that enable it to be attached to standard plumbing fixtures, in some embodiments different shapes may be used for the housing such as but not limited to, rectangular, oval, or other shapes for functional and/or aesthetic needs. The interior of top cover 152 is configured to house and position other components of shower head 150, including compression springs 156. O-ring 154 is fit into a groove above an outer threaded section of top cover 152 and provides a water tight seal for the showerhead when top cover 152 and faceplate 166 are secured together. O-ring 154 may be made of a resilient material that prevents water from escaping around the edges of the assembly, ensuring that water flows through the intended pathways within shower head 150.

Compression springs 156 are positioned beneath top cover 152 in a specific pattern. Compression springs 156 provide mechanical force that pushes needle plate 160 downward toward faceplate 166. These springs are calibrated to exert sufficient pressure to create a seal when water pressure is absent while enabling movement when water pressure is present. Compression springs 156 are supported at their upper end by features within top cover 152 and at their lower end by needle plate 160. O-ring 158 is fitted into an outer O-ring groove on an upper surface of needle plate 160, while O-ring 162 is fitted into an inner O-ring groove on a lower surface of needle plate 160. These O-rings 158 and 162 create a sealed chamber below needle plate 160 where water flows into. As water enters the chamber, pressure builds up under needle plate 160, pushing the plate upward against the force of the compression springs 156, causing conical pins 161 to retract from conical nozzle opening 165.This arrangement enables water pressure to effectively move needle plate 160 against the resistance of compression springs 156 and enables water to flow through the openings 165.

Needle plate 160 is a disc-shaped component that holds conical pins 161 in a pattern that corresponds to conical nozzle openings 165 in faceplate 166. Needle plate 160 moves vertically (i.e. in a longitudinal direction) within shower head 150 in response to water pressure. When water enters shower head 150, pressure builds in the chamber containing needle plate 160, pushing needle plate 160 upward against compression springs 156. This upward movement retracts conical pins 161 from conical nozzle openings 165, creating gaps through which water can flow.

Conical pins 161 extend from the lower surface of needle plate 160 and are aligned with conical nozzle openings 165 in faceplate 166. Conical pins 161 have a tapered shape that corresponds to the shape of conical nozzle openings 165. When needle plate 160 is in its lowest position (when no water pressure is present), conical pins 161 insert fully into conical nozzle openings 165, creating a watertight seal. As needle plate 160 moves upward under water pressure, conical pins 161 withdraw partially from conical nozzle openings 165, creating annular gaps around each pin through which water can flow.

O-ring 164 is fitted into an inner groove on faceplate 166, creating a seal between faceplate 166 and top cover 152. This seal ensure water from the inlet does not enter an upper cavity above needle plate 160, the upper cavity being the location of springs 156. This upper cavity remains free of water, as water enters lower cavity where conical pins 161 are positioned. These O-rings work together to direct water flow properly through shower head 150, ensuring that water pressure acts on a bottom surface of needle plate 160 to push the plate upwards against compression springs 156. When water pressure is absent, the compressions spring 156 push down on needle plate 160 to seal the conical openings. .

Faceplate 166 forms the lower portion of shower head 150 and contains nozzle openings 165 through which water exits the assembly. Faceplate 166 has a generally circular shape that matches the profile of needle plate 160 and top cover 152. The exterior surface of faceplate 166 may have a decorative finish that complements bathroom fixtures. Faceplate 166 attaches to top cover 152, either directly or through intermediate components, to create the enclosed housing of shower head 150.

Conical nozzle openings 165 are formed in faceplate 166 in a pattern matching conical pins 161 on needle plate 160. Conical nozzle openings 165 have a tapered, conical shape that narrows from the interior side to the exterior side of faceplate 166. In some embodiments the openings can be aligned in rows. The tapering of conical nozzle openings 165 enables for a tight seal when conical pins 161 are fully inserted and may create a specific spray pattern when water flows through the partial openings. The size, angle, and arrangement of conical nozzle openings 165 may be configured to produce various desired spray patterns, from a fine mist to a more focused stream.

The drip-stop functionality of shower head 150 operates on a balance of forces between water pressure and compression springs 156. During normal operation, water pressure entering through top cover 152 exerts force on needle plate 160, pushing it upward against compression springs 156. This upward movement creates flow paths between conical pins 161 and conical nozzle openings 165, enabling water to pass through shower head 150. As water pressure increases, needle plate 160 moves further upward, creating larger flow paths and maintaining consistent water velocity despite pressure variations.

When water supply is turned off and pressure decreases, compression springs 156 gradually push needle plate 160 downward, inserting conical pins 161 further into conical nozzle openings 165. Once water pressure drops below the force exerted by compression springs 156, conical pins 161 fully seat in conical nozzle openings 165, creating a watertight seal that prevents any remaining water from dripping out of shower head 150.

In some embodiments, the number of compression springs 156 may be increased or decreased based on the size of shower head 150 and the desired force distribution across needle plate 160. In some embodiments, compression springs 156 may be replaced by other elastic elements such as elastomeric membranes, rubber gaskets, or leaf springs that provide similar biasing force while potentially reducing manufacturing complexity. In some embodiments, different arrangements of compression springs 156 may be implemented, such as using springs with varying spring constants or placing springs strategically to create zones of different pressure sensitivity within shower head 150.

In some embodiments, conical pins 161 may have different shapes, such as cylindrical, spherical, or stepped profiles, while still maintaining the ability to create a seal with corresponding shaped openings in faceplate 166. In some embodiments, the arrangement and size of conical pins 161 and conical nozzle openings 165 may be modified to create specialized spray patterns or to accommodate different flow rate requirements.

In some embodiments, faceplate 166 may include additional features such as mixing chambers before conical nozzle openings 165 to modify the water flow characteristics.

In some embodiments, the configuration of shower head 150 may be modified to incorporate aspects of manual adjustment while maintaining the pressure-responsive drip-stop functionality. For example, needle plate 160 may include an adjustment mechanism that allows users to set a baseline position for conical pins 161 relative to conical nozzle openings 165, while still enabling automatic movement in response to water pressure. This hybrid configuration would enable users to customize the default spray pattern while preserving the automatic drip prevention when water is turned off.

FIGS. 1C and 1D provide cross-sectional views of shower head 150, illustrating how these components interact when the shower is turned off (closed position) and turned on (open position), respectively. These figures further demonstrate the movement of needle plate 160 and conical pins 161 in response to water pressure changes.

FIG. 1C illustrates a cross-sectional view of shower head 150 in a closed position, corresponding to a state where water pressure is absent or below the threshold needed to overcome the force of compression springs 156. In this view, shower head 150 is shown with top cover 152, compression springs 156, conical pins 161, faceplate 166, and conical nozzle openings 165.

In the closed position shown in FIG. 1C, compression springs 156 exert downward force on needle plate 160, which positions conical pins 161 fully inserted into conical nozzle openings 165 in faceplate 166. This configuration occurs when water is not flowing through shower head 150, such as when the shower handle 102 is turned to the off position. When conical pins 161 are fully seated in conical nozzle openings 165, they create a watertight seal that prevents any residual water within shower head 150 from dripping out. The tapered shape of conical pins 161 and conical nozzle openings 165 ensures a complete seal around the perimeter of each opening. This sealing mechanism is what provides the drip-stop functionality of shower head 150.

Compression springs 156 maintain constant pressure on needle plate 160, ensuring that conical pins 161 remain seated in conical nozzle openings 165 until sufficient water pressure builds up to overcome the spring force. The spring force is calibrated to be strong enough to maintain the seal even with the weight of residual water in shower head 150, yet not so strong that normal water pressure cannot overcome it during operation.

FIG. 1D illustrates a cross-sectional view of shower head 150 in an open position, corresponding to a state where water pressure is present and exceeds the threshold needed to compress springs 156. Similar to FIG. 1C, this view shows shower head 150 with top cover 152, compression springs 156, conical pins 161, faceplate 166, and conical nozzle openings 165, but in a different operational state.

In the open position shown in FIG. 1D, water pressure entering through top cover 152 has pushed needle plate 160 upward, compressing springs 156 and retracting conical pins 161 partially or fully from conical nozzle openings 165. When conical pins 161 are retracted from conical nozzle openings 165, annular gaps form around each pin through which water can flow. These gaps enable water to exit shower head 150 in a controlled spray pattern. The size of these gaps is directly proportional to the water pressure—higher pressure results in larger gaps as needle plate 160 moves further upward against compression springs 156.

This pressure-dependent positioning creates a self-regulating flow mechanism. As water pressure increases, the gaps between conical pins 161 and conical nozzle openings 165 widen, enabling more water to flow while maintaining consistent velocity. Conversely, as water pressure decreases, the gaps narrow, reducing flow volume but maintaining spray force. This characteristic helps provide a consistent shower experience across varying water pressure conditions.

The transition between the closed position of FIG. 1C and the open position of FIG. 1D occurs automatically in response to water pressure changes. When shower handle 102 is turned on, water pressure builds within shower head 150, gradually pushing needle plate 160 upward against compression springs 156 until water begins to flow. When shower handle 102 is turned off, decreasing water pressure enables compression springs 156 to push needle plate 160 downward, gradually reducing flow until conical pins 161 fully seat in conical nozzle openings 165, stopping all flow. This automatic response to pressure changes provides both the drip-stop functionality when water is turned off and pressure compensation during normal operation. The continuous interaction between water pressure and spring force creates a dynamic system that adapts to changing conditions without requiring user intervention or external power sources.

The repeated movement of conical pins 161 in and out of conical nozzle openings 165 during normal operation serves an additional function of clearing mineral deposits and debris. As water flows through shower head 150, minerals contained in the water can accumulate on surfaces, particularly around conical nozzle openings 165. The regular motion of conical pins 161 extending into and retracting from conical nozzle openings 165 mechanically dislodges these developing deposits before they can harden and restrict water flow. This self-cleaning action occurs naturally during the normal pressure fluctuations experienced in typical use, helping to maintain the performance of shower head 150 over time without requiring manual cleaning.

In some embodiments, the degree to which conical pins 161 retract from conical nozzle openings 165 may be limited by mechanical stops within shower head 150, establishing a maximum flow rate. In some embodiments, the relative positions of conical pins 161 and conical nozzle openings 165 may be configured to create specific spray characteristics at different pressure levels.

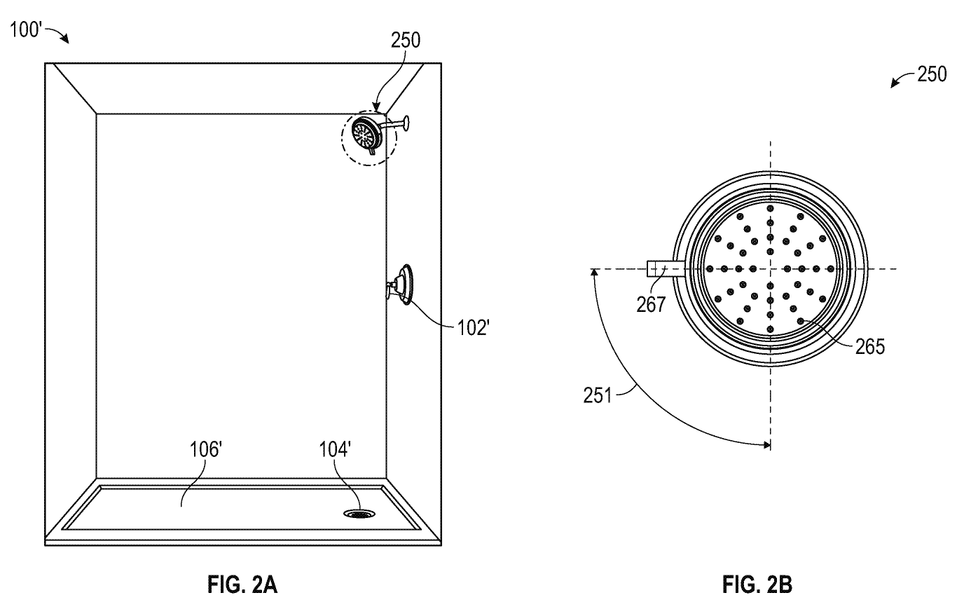

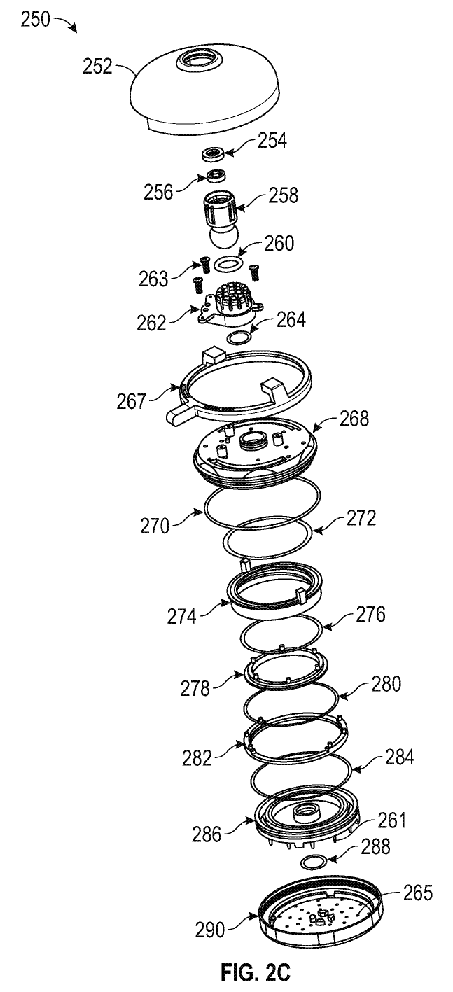

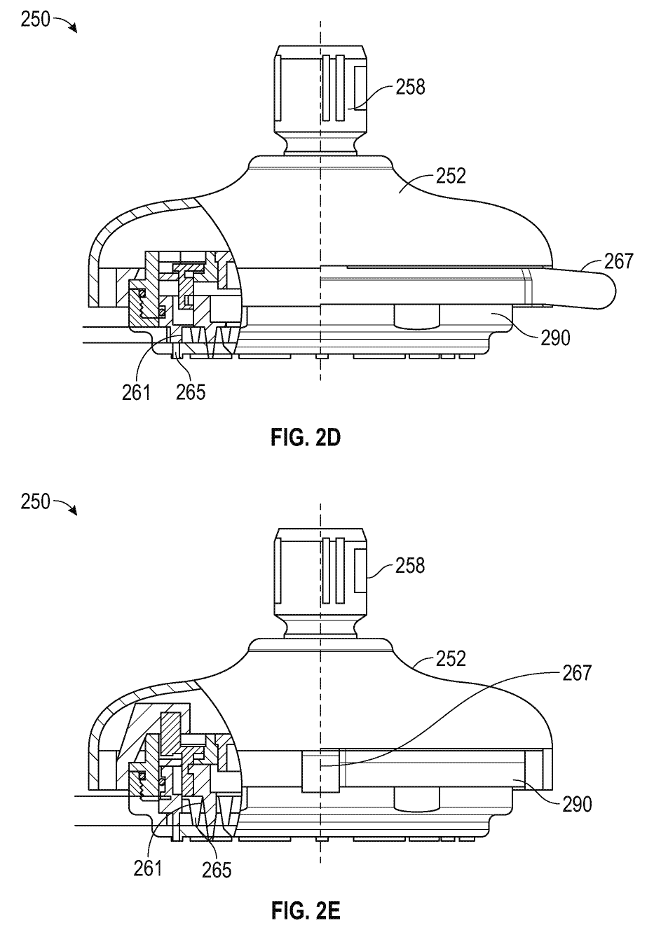

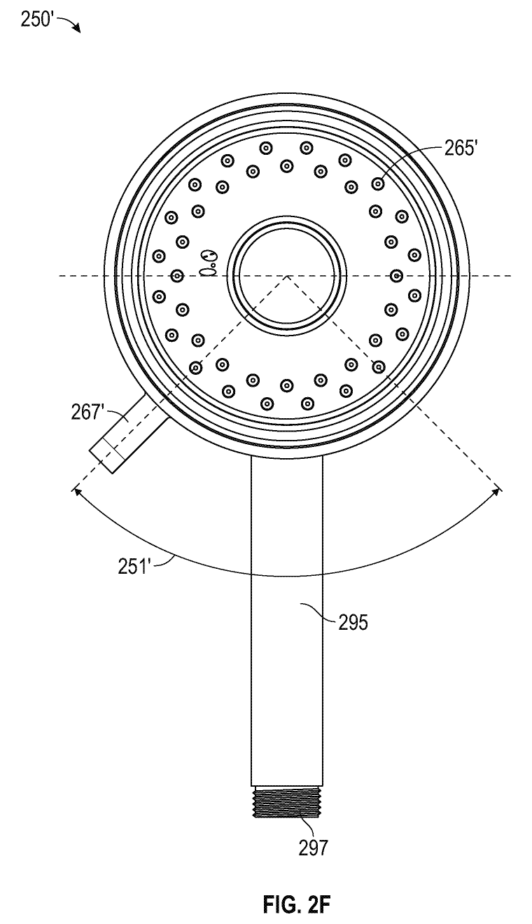

Having described the pressure-responsive drip-stop of shower head 150, FIGS. 2A-2F will now illustrate another embodiment of shower head that incorporates similar approach using manual adjustment of spray characteristics through a similar but distinctly controlled pin and nozzle arrangement.

FIG. 2A illustrates a shower enclosure 100' with manually adjustable shower head 250 installed. Shower enclosure 100' includes shower handle 102', drain 104', and floor 106', which serve similar functions to their counterparts described in relation to FIG. 1A.

Manually adjustable shower head 250 represents another embodiment of the fluid control device that enables users to manually adjust spray characteristics rather than relying solely on automatic pressure response. While shower head 150 described previously uses water pressure to automatically position conical pins relative to nozzle openings, manually adjustable shower head 250 incorporates a user-operated mechanism to adjust the position of similar components.

Manually adjustable shower head 250 connects to the water supply system through shower handle 102', which controls water flow and temperature. Manually adjustable shower head 250 maintains the user-selected spray pattern regardless of water pressure fluctuations, providing consistent spray characteristics throughout use. Manually adjustable shower head 250 enables users to select from a range of spray patterns, from a gentle, wider spray to a more forceful, concentrated spray. This adjustment capability is achieved through a mechanical system that controls the position of internal pins relative to nozzle openings, similar to the arrangement in shower head 150 but operated by user input rather than water pressure.

FIG. 2B provides a top view of manually adjustable shower head 250, showing rotary lever 267, angle of movement 251, and conical nozzle openings 265. This view illustrates the user interface and spray outlet arrangement of manually adjustable shower head 250.

Rotary lever 267 extends from the side of manually adjustable shower head 250 and serves as the control mechanism for adjusting spray characteristics. Users can rotate rotary lever 267 through angle of movement 251 to change the relative position of internal components. This angle of movement 251 can be anywhere from 0-360 degrees, wherein each incremental movement changes the spray pattern by adjusting the relative positions of internal components.

In some embodiments, angle of movement 251 may be 90 degrees to achieve a complete range of spray patterns while maintaining a compact design and intuitive user experience. In some embodiments, rotary lever 267 may include markings or detents to indicate specific spray settings within the range of movement.

Conical nozzle openings 265 are arranged in a pattern across the face of manually adjustable shower head 250. These openings function similarly to conical nozzle openings 165 in shower head 150, serving as outlets through which water exits the shower head. The spray pattern produced by conical nozzle openings 265 varies based on the position of internal conical pins relative to these openings, which is controlled by the position of rotary lever 267.When rotary lever 267 is positioned at one end of angle of movement 251, conical pins inside manually adjustable shower head 250 are positioned to create maximum restriction in conical nozzle openings 265, producing a high-velocity, concentrated spray sometimes referred to as a "needle spray." As rotary lever 267 is rotated toward the opposite end of angle of movement 251, conical pins gradually withdraw from conical nozzle openings 265, creating a gentler, more diffused spray pattern. Manually adjustable shower head 250 maintains the selected pin position regardless of pressure fluctuations. This enables users to choose their preferred spray pattern and maintain that selection throughout their shower experience, even as water pressure may vary slightly due to other water usage in the building.

The control mechanism connecting rotary lever 267 to the internal components of manually adjustable shower head 250 will be described in more detail in subsequent figures, particularly in relation to the exploded view shown in FIG. 2C.

FIG. 2C illustrates an exploded view of manually adjustable shower head 250, showing the various components that enable manual adjustment of spray patterns. This figure reveals how manually adjustable shower head 250 simplifies traditional shower head design by using a single set of nozzles to create multiple spray patterns rather than requiring separate sets of nozzles for each pattern.

Cover 252 forms the upper housing portion of manually adjustable shower head 250. Cover 252 includes an inlet for connecting to the water supply and provides structural support for the internal components. Mesh gasket 254 sits below cover 252 and helps distribute water flow evenly within manually adjustable shower head 250. Flow restrictor 256 is positioned beneath mesh gasket 254 and helps maintain water flow within regulated limits for water conservation. Shower ball joint 258 connects to the water supply and enables manually adjustable shower head 250 to be angled in different directions. O-ring 260 creates a watertight seal around shower ball joint 258. Shower socket 262 houses shower ball joint 258 and connects to cover 252. Screw 263 secures shower socket 262 to cover 268, while O-ring 264 provides additional sealing. O-ring 264 fits into an O-ring groove around the inlet on the top cover 268, sealing the connection between shower socket 262 and inlet on top cover 268. Together, these components create the connection between the water supply and the internal mechanism of manually adjustable shower head 250.

Rotary lever 267 extends through an opening in the side of manually adjustable shower head 250 and connects to quarter-turn spindle 274. Rotary lever 267 enables users to manually control the internal mechanism that adjusts spray patterns. Top cover 268 sits below shower socket 262 and houses the quarter-turn mechanism. The quarter-turn mechanism includes multiple components that work together to convert the rotational movement of rotary lever 267 into linear movement of needle plate 286. O-ring 270 and upper friction ring 272 sit above quarter-turn spindle 274. Quarter-turn spindle 274 is a component with a threaded lower section that engages with needle plate 286. When rotary lever 267 rotates quarter-turn spindle 274, the threading causes needle plate 286 to move linearly, either toward or away from face plate 290.

Inner friction ring 276 and inner bracket 278 fit within quarter-turn spindle 274, while outer friction ring 280 and outer bracket 282 fit around the outside of quarter-turn spindle 274. These components stabilize quarter-turn spindle 274 while enabling it to rotate smoothly. O-ring 284 fits into an outer-ring groove on needle plate 286, while O-ring 288 is placed in an inner O-ring groove on needle plate 286. This creates a sealed chamber between needle plate 286 and faceplate 290 where the water will flow. Needle plate 286 includes conical pins 261 that align with conical nozzle openings 265 in face plate 290. Needle plate 286 has threading that engages with quarter-turn spindle 274, causing needle plate 286 to move linearly when quarter-turn spindle 274 rotates. This linear movement adjusts the position of conical pins 261 relative to conical nozzle openings 265, creating varying spray patterns. O-ring 288 seals the perimeter of needle plate 286, ensuring water flows through the gaps between conical pins 261 and conical nozzle openings 265 rather than around the edges.

Face plate 290 forms the bottom portion of manually adjustable shower head 250 and contains conical nozzle openings 265 through which water exits. Face plate 290 is securely attached to the other components to create the enclosed housing of manually adjustable shower head 250.

When assembled, these components create a manually adjustable mechanism that controls water flow patterns. Water enters through cover 252 and flows into the chamber below needle plate 286. The position of needle plate 286 and its conical pins 261 relative to conical nozzle openings 265 in face plate 290 is controlled by the rotation of quarter-turn spindle 274, which is operated by rotary lever 267. As rotary lever 267 is turned, quarter-turn spindle 274 rotates, and the threaded connection between quarter-turn spindle 274 and needle plate 286 converts this rotational movement into linear movement, either raising or lowering needle plate 286.

When needle plate 286 is in its lowest position, conical pins 261 extend furthest into conical nozzle openings 265, creating the seal and can also create the smallest possible gap between the openings and the pins. Water flowing through these restricted gaps accelerates, producing a high-velocity "needle spray" that can be used for deep cleaning or massaging effects. As rotary lever 267 is rotated, needle plate 286 gradually rises, retracting conical pins 261 from conical nozzle openings 265 and creating larger gaps. These larger gaps enable water to flow more gently, producing a softer, more diffuse spray pattern suitable for regular showering or rinsing.

This approach simplifies the internal design while potentially offering more spray variations than traditional multi-mode shower heads. The user can select any point along the spectrum from high-velocity to gentle spray by positioning rotary lever 267 at the corresponding point within its range of movement.

The water flow path through manually adjustable shower head 250 remains consistent regardless of the selected spray pattern, with only the gap size between conical pins 261 and conical nozzle openings 265 changing. This consistent flow path helps maintain even water distribution across all nozzles while reducing the possibility of internal flow restrictions that might occur in conventional diverter-based systems.

In some embodiments, the manually adjustable variable cross-section nozzle system of shower head 250 can be adapted for use in other water fixtures beyond fixed shower heads. This can be implemented in hand showers, faucet spray heads, garden hose nozzles, irrigation systems, industrial spray nozzles, kitchen sink sprayers, body jets in shower systems, outdoor misting systems, and water features, among others. The mechanism—using adjustable pins and nozzles to create variable spray patterns—remains consistent across these applications, with adaptations to suit the specific form factor and user interface requirements of each fixture type.

In some embodiments, the threading on quarter-turn spindle 274 and needle plate 286 may have different pitches to provide varying levels of adjustment precision. In some embodiments, rotary lever 267 may include detents that provide tactile feedback at specific positions corresponding to predetermined spray patterns.

In some embodiments, conical pins 261 may have different shapes or profiles along needle plate 286 to create complex spray patterns that vary across the face of manually adjustable shower head 250. In some embodiments, conical nozzle openings 265 may be arranged in specific patterns or groups to create signature spray experiences.

In some embodiments, manually adjustable shower head 250 may incorporate aspects of the pressure-compensating mechanism from shower head 150, creating a hybrid system that enables both manual adjustment and automatic pressure compensation. This could potentially combine the benefits of user-selected spray patterns with automatic drip prevention. For example, the quarter-turn mechanism may be supplemented with a secondary spring-loaded component that provides automatic sealing when water pressure drops completely, while still enabling manual adjustment during normal operation. This would combine the benefits of user-controlled spray patterns with automatic drip prevention. In some embodiments, the internal components may be reconfigured to enable horizontal rather than vertical movement of needle plate 286, or the quarter-turn spindle 274 may be replaced with alternative conversion mechanisms such as cam systems while maintaining the core functionality of adjusting the relationship between conical pins 261 and conical nozzle openings 265.

By using a single set of adjustable nozzles rather than multiple sets of fixed nozzles, manually adjustable shower head 250 can achieve a wider range of spray patterns with fewer components. This potentially improves reliability while reducing manufacturing complexity compared to conventional designs that require internal diverter valves and multiple nozzle sets.

FIGS. 2D and 2E provide cross-sectional views of manually adjustable shower head 250, illustrating the operation of these components in different positions corresponding to different spray patterns.

FIG. 2D illustrates a cross-sectional view of manually adjustable shower head 250 in a closed or near closed position, showing top cover 252, shower ball joint 258, rotary lever 267, conical pins 261, conical nozzle openings 265, and face plate 290. This configuration corresponds to rotary lever 267 being positioned to create a high-velocity spray pattern or completely sealed position. In this position, conical pins 261 extend into conical nozzle openings 265, fully closing the opening or creating minimal gaps between the opening and the pins. The minimized gaps may create the smallest functional opening for water flow, which may produce a high-velocity, concentrated spray pattern.

When rotary lever 267 is positioned in the closed position or near closed position, quarter-turn spindle 274 has rotated to a position that places needle plate 286 at its lowest point. The threaded connection between quarter-turn spindle 274 and needle plate 286 converts the rotational position of rotary lever 267 into this specific vertical position of needle plate 286 and its conical pins 261. Water entering through shower ball joint 258 flows through the internal chambers of manually adjustable shower head 250 and exits through the restricted gaps between conical pins 261 and conical nozzle openings 265 or if the pins are full closed, restrict water flow completely. The restriction created by conical pins 261 being inserted into conical nozzle openings 265 accelerates the water, creating a forceful spray suitable for targeted cleaning, massage effects, or rinsing stubborn residue.

FIG. 2E illustrates a cross-sectional view of manually adjustable shower head 250 in an open position, showing the same components as FIG. 2D but in a different configuration. This position corresponds to rotary lever 267 being rotated to create a gentler, more diffused spray pattern. In the position shown in FIG. 2E, the rotary lever 267 has been rotated to a position that raises needle plate 286 to its highest point. This movement retracts conical pins 261 from conical nozzle openings 265, creating the maximum possible gaps between them. These larger gaps enable water to flow more freely and with less restriction. When water passes through these complete opening, the water maintains more of its original pressure and spreads more widely upon exiting manually adjustable shower head 250. This may create a gentle, rain-like spray pattern suitable for comfortable showering, bathing children, or rinsing delicate items.

By comparing FIGS. 2D and 2E, the adjustable range of manually adjustable shower head 250 becomes apparent. Rotary lever 267 can be positioned anywhere between these two extremes, providing a continuous spectrum of spray patterns from gentle to high-velocity to completely closed. This enables users to select precisely the spray characteristics that best suit their preferences or specific tasks.

FIG. 2F illustrates a front view of a hand shower variation of the manually adjustable shower head as a hand shower. This figure shows hand shower 250' with conical nozzle openings 265', rotary lever 267', angle of movement 251', handle 295, and inlet 297. Hand shower 250' incorporates the same manually adjustable nozzle and similar components as shower head 250 but in a handheld configuration. Handle 295 extends from the main body of hand shower 250' and provides a comfortable grip for users. Inlet 297 at the bottom of handle 295 connects to a flexible hose that supplies water from a plumbing system.

Rotary lever 267' extends from the side of hand shower 250' and functions identically to rotary lever 267 in shower head 250. Users can rotate rotary lever 267' through angle of movement 251' to adjust the spray pattern produced by conical nozzle openings 265'. This hand shower configuration provides the additional benefit of mobility, enabling users to direct the selected spray pattern precisely where needed. The internal mechanism of hand shower 250' mirrors that of shower head 250, with a quarter-turn spindle connected to rotary lever 267' that adjusts the position of an internal needle plate with conical pins relative to conical nozzle openings 265'.

The drip-stop shower head 150 and manually adjustable shower head 250 represent similar approaches to fluid control using similar mechanical principles. Both configurations utilize the interaction between conical pins and conical nozzle openings to control water flow. Shower head 150 employs automatic pressure response to simultaneously achieve drip prevention and pressure compensation. When water pressure decreases below a threshold, compression springs automatically move the needle plate to seal the nozzle openings, preventing drips. During normal operation, varying water pressure automatically adjusts the position of the needle plate, potentially providing more consistent spray velocity across pressure fluctuations. Shower head 250 uses manual adjustment to provide user-selected spray patterns. The position of the needle plate is determined by the user's setting of the rotary lever rather than by water pressure. This manual control enables users to select their preferred spray pattern regardless of water pressure, maintaining that selection until manually changed.

In some embodiments, elements of both configurations could be combined. For example, a manually adjustable shower head could incorporate spring-loaded components that provide drip prevention when water is turned off while still enabling manual adjustment of spray patterns during operation. Similarly, a pressure-compensating shower head could include user-adjustable features that set the baseline position of the needle plate, enabling customization of the spray characteristics while maintaining automatic pressure response.

In some embodiments, needle plate of both configurations can be made from a ridged material to maintain structural integrity such as engineering plastics, zinc, stainless steel, or brass. Face plate of both configurations may be made from the same rigid materials as the needle plate and can also be made of flexible materials such as silicon.

Both approaches offer advantages over conventional approaches by achieving multiple functions with a single set of nozzles rather than requiring separate sets for different spray patterns. This potentially reduces manufacturing complexity and component count while providing equal or superior functionality compared to traditional shower heads.

The fluid control principles demonstrated in these embodiments can be applied across various water fixtures, representing a versatile platform technology with applications in residential, commercial, and industrial settings where controlled fluid delivery is desired.

### Conclusion

Many modifications and other embodiments of the disclosures set forth herein will come to mind to one skilled in the art to which these present disclosures pertain having the benefit of the teachings presented in the foregoing descriptions and the associated drawings. Therefore, it is to be understood that the embodiments of the present disclosure are not to be limited to the specific embodiments disclosed and that modifications and other embodiments are intended to be included within the scope of the present disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the present disclosure. In this regard, for example, different combinations of elements and/or functions than those explicitly described above are also contemplated within the scope of the present disclosure. Although specific terms are employed herein, they are used in a generic and descriptive sense only and not for purposes of limitation.

1. A fluid control device comprising:
a first element comprising a plurality of openings;
a second element positioned adjacent to the first element, the second element comprising a plurality of pins, wherein the plurality of pins are aligned with the plurality of openings of the first element;
wherein one of the first element or the second element is movable relative to the other element between a first position and a second position, the first position allowing fluid flow through the plurality of openings and the second position modifying the fluid flow through the plurality of openings; and
an actuator configured to move one of the first element or the second element relative to the other element.

2. The fluid control device of claim 1, wherein the first element comprises a top surface and a bottom surface, and wherein the plurality of openings extend from the top surface to the bottom surface.

3. The fluid control device of claim 2, wherein the second element comprises a top surface and a bottom surface, and wherein the plurality of pins extend from the bottom surface of the second element toward the first element.

4. The fluid control device of claim 3, wherein the bottom surface of the second element is positioned above the top surface of the first element.

5. The fluid control device of claim 1, wherein each of the plurality of openings of the first element comprises a shape configured to receive a corresponding pin of the plurality of pins.

6. The fluid control device of claim 1, wherein the actuator comprises a pressure-responsive mechanism configured to automatically adjust the position of one of the first or second element relative to the other element based on fluid pressure.

7. The fluid control device of claim 6, wherein the pressure-responsive mechanism comprises a spring-loaded assembly configured to: push the plurality of pins into the plurality of openings when fluid pressure is below a threshold; and enable the plurality of pins to retract from the plurality of openings when fluid pressure exceeds the threshold.

8. The fluid control device of claim 1, wherein the actuator comprises a manual control mechanism configured to enable user adjustment of the position of one the first or second element relative to the other element.

9. The fluid control device of claim 8, wherein the manual control mechanism comprises a rotary lever connected to a spindle, wherein the spindle is configured to convert rotational movement into linear movement of one the first or second element relative to the other element.

10. The fluid control device of claim 1, wherein in the second position, the plurality of pins extend into the plurality of openings to create a reduced cross-sectional area for fluid flow.

11. The fluid control device of claim 1, wherein in the first position, the plurality of pins are retracted from the plurality of openings to create a maximum cross-sectional area for fluid flow.

12. The fluid control device of claim 1, wherein when the plurality of pins fully extend into the plurality of openings, fluid flow is completely stopped.

13. The fluid control device of claim 1, wherein the first position and second position define a range of intermediate positions therebetween, wherein each intermediate position is configured to create a different water flow rate based on the degree to which the plurality of pins extend into the plurality of openings.

14. The fluid control device of claim 1, wherein the relative movement between the first element and the second element is in a longitudinal direction.

15. The fluid control device of claim 1, wherein the plurality of pins and the plurality of openings are configured to create larger flow gaps when fluid pressure increases and smaller flow gaps when fluid pressure decreases.

16. The fluid control device of claim 1, wherein the plurality of pins have a tapered shape configured to create a seal when fully inserted into the plurality of openings.

17. The fluid control device of claim 1, wherein movement of the plurality of pins into and out of the plurality of openings during operation provides a self-cleaning function.

18. The fluid control device of claim 1, wherein the fluid control device is configured to produce multiple spray patterns.

19. The fluid control device of claim 1, wherein the first element and the second element form a chamber that is configured to receive fluid, and wherein the fluid in the chamber causes fluid pressure that contributes to the movement between the first position and the second position.

20. The fluid control device of claim 1, wherein the fluid control device is configured to convert between spray patterns without redirecting fluid flow through separate fluid pathways.
